(19) United States
(12) Patent Application Publication
(10) Pub. No.: US 2013/0160747 A1
(43) Pub. Date: Jun. 27, 2013

(54) SYSTEM AND METHOD FOR STARTING AN ENGINE IN MOBILE LIQUID NATURAL GAS APPLICATIONS

(71) Applicants: Dennis H. Gibson, Chillicothe, IL (US); Vishnu Irigireddy, Chillicothe, IL (US)

(72) Inventors: Dennis H. Gibson, Chillicothe, IL (US); Vishnu Irigireddy, Chillicothe, IL (US)

(73) Assignee: Caterpillar Inc., Peoria, IL (US)

(21) Appl. No.: 13/336,100

(22) Filed: Dec. 23, 2011

(51) Int. Cl. F02M 31/02

(52) U.S. Cl. 123/557

(57) ABSTRACT

The present disclosure is directed to a system for running an engine. The system includes a first tank, a second tank, a pump, a vaporizer, and a heat source. The first tank stores liquid natural gas (LNG). The pump is in communication with the first tank and is configured to pump the LNG from the first tank. The vaporizer is in communication with the pump. The vaporizer is configured to receive the LNG from the first tank via the pump and convert the LNG into compressed natural gas (CNG). The second tank is in communication with the vaporizer. The second tank is configured to store CNG. A heat source is in communication with the second tank. The heat source uses the stored CNG to apply heat to the vaporizer.

### TECHNICAL FIELD

The present disclosure relates generally to a system and method for running an engine in mobile liquid natural gas applications.

### BACKGROUND

Current mobile liquid natural gas (LNG) applications use engine jacket cooling water as a vaporizer/heat source to vaporize LNG to compressed natural gas (CNG). A problem can arise with this approach in that until the engine is warmed up there is no heat to power the vaporizer. As a result, operations with CNG must wait until the engine reaches its normal operating temperature. During cold winters in areas such as the Arctic Circle, such engines may not reach their operating temperatures until load is applied. This can cause an unnecessary delay before such a system can be put to use under such temperature conditions. Thus, what is desired is an improved system and method that reduces the time it takes to before an engine is able to run on CNG in certain weather conditions.

U.S. Pat. No. 7,069,730 (the '730 patent) issued to Emmer et al. discloses a system that dispenses both LNG and CNG. A bulk tank contains a supply of LNG which is pumped to a smaller storage tank. After the storage tank is filled, LNG from the bulk tank is pumped to a vaporizer so that CNG is produced. Although the '730 patent discloses LNG and CNG holding tanks, the '730 patent fails to disclose a system that facilitates an engines to gain faster access to CNG in spite of weather conditions.

It is therefore desirable to provide, among other things, an improved system and method for running an engine in mobile liquid natural gas applications.

### SUMMARY

In accordance with one embodiment, the present disclosure is directed to a system that includes an engine, a vaporizer, a tank and a heat source. The vaporizer is configured to convert liquid natural gas (LNG) to compressed natural gas (CNG). The tank is configured to store compressed natural gas. A heat source is in fluid communication with the tank and fueled by the CNG. The heat source is configured to apply heat to the vaporizer.

In another embodiment, the present disclosure is directed to a system for running an engine. The system includes a first tank, a second tank, a pump, a vaporizer, and a heat source. The first tank stores liquid natural gas (LNG). The pump is in communication with the first tank and is configured to pump the LNG from the first tank. The vaporizer is in communication with the pump. The vaporizer is configured to receive the LNG from the first tank via the pump and convert the LNG into compressed natural gas (CNG). The second tank is in communication with the vaporizer. The second tank is configured to store CNG. A heat source is in communication with the second tank. The heat source uses the stored CNG to apply heat to the vaporizer.

In another embodiment, the present disclosure is directed to a method for running an engine. The method includes receiving liquid natural gas (LNG) from a first tank. A vaporizer is used to convert the LNG to compressed natural gas (CNG). A portion of the CNG is stored in a second tank prior to shutdown of the engine. The stored CNG is converted into heat via a heat source. The heat is applied to the vaporizer to convert LNG to CNG.

In yet another embodiment, the present disclosure is directed to a fuel system. The fuel system includes a first fuel source, a second fuel source, a first fuel rail, a second fuel rail, a first fuel pump, a second fuel pump, a quill, at least one fuel injector, a vaporizer, a tank, and a heat source. The first fuel pump is configured to pressurize the first fuel associated with the first fuel source. The vaporizer is in communication with the first fuel source via the first fuel pump. Such vaporizer may be configured to convert the first fuel from a liquid form to a gaseous form. The tank is in communication with the vaporizer and can be configured to store the gaseous form of the first fuel. The heat source is in communication with the tank. Such heat source may be configured to convert the gaseous form of the first fuel into heat and apply the heat to the vaporizer. The second fuel pump is configured to pressurize a second fuel associated with the second fuel source and deliver the second fuel to the second fuel rail. The quill is in communication with the first fuel from the first fuel rail and the second fuel from the second fuel rail. At least one dual fuel injector is configured to receive both the first fuel and the second fuel from the quill.

### BRIEF DESCRIPTION OF THE DRAWINGS

FIG. 1 illustrates a schematic diagram of components of a fuel system in accordance with one embodiment.

FIG. 2 illustrates in flow-chart form a method of running an engine having a duel fuel system in accordance with one embodiment.

### DETAILED DESCRIPTION

Reference will now be made in detail to exemplary embodiments, which are illustrated in the accompanying drawings. Wherever possible, the same reference numbers will be used throughout the drawings to refer to the same or like parts.

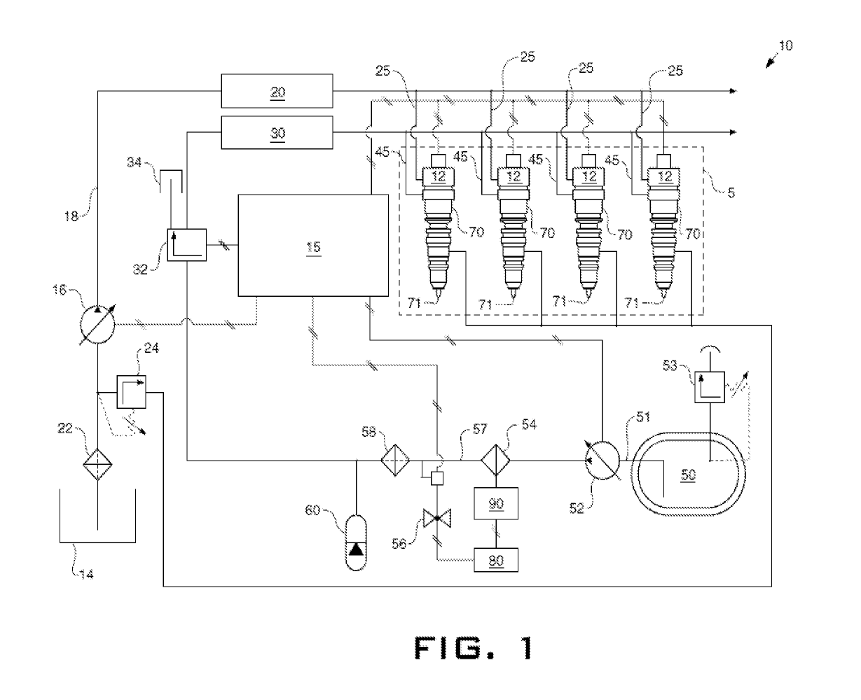

FIG. 1 illustrates a schematic diagram of components of a fuel system in accordance with one embodiment. The dual fuel common rail fuel system 10 utilizes dual fuel common rail injectors 12. The dual fuel system 10 includes a plurality of fuel injectors 12 that each include an injector body 70 with a tip component 71 positioned for direct injection of gaseous fuel and/or liquid fuel into respective combustion chambers of associated engine cylinders (not shown). A diesel fuel source 14 contains diesel fuel. A diesel pump 16 draws diesel fuel through diesel supply line 18; pressurizes the diesel fuel; and delivers the pressurized diesel fuel to a diesel fuel rail 20. A filter 22 may be disposed in the diesel supply line 18 upstream of the diesel pump 16 and downstream of the diesel fuel source 14. The filter 22 serves to screen out dirt and rust particles from the fuel. Diesel fuel within the diesel fuel rail 20 may be pressurized to a pressure of approximately 40 MPa at approximately 90° C. Pressurized diesel fuel from the diesel fuel rail 20 may then be delivered to the injectors 12 via diesel fuel line 25.

A quill assembly (not shown) can be used to deliver the diesel fuel from the diesel fuel rail 20 to the injectors 12. Such quill assembly can be configured to receive both diesel fuel and a gaseous fuel such as natural gas. The gaseous fuel from the gaseous rail 30 may be delivered to the injectors 12 as compressed natural gas via gaseous fuel line 45. The quill assembly may further be a coaxial type wherein diesel fuel is disposed within a first quill tube, which is disposed within a second quill tube that carries gaseous fuel. Those skilled in the art will recognize that the gaseous fuel may be any gaseous fuel such as natural gas, propane, methane, liquefied petroleum gas (LPG), synthetic gas, landfill gas, coal gas, biogas from agricultural anaerobic digesters, or any other gaseous fuel.

A back-pressure control valve 24 can be connected between the injectors 12 and the diesel fuel tank 14 to return a quantity of the fuel back to the diesel fuel tank 14 in order to control pressure in liquid fuel common rail 20.

In the illustrated embodiment, natural gas is maintained in a liquid state in a cryogenic liquefied natural gas tank 50 (e.g., gaseous fuel source 50). Gaseous fuel, such as liquefied natural gas may be stored at relatively low temperatures and pressures (−160° C. and 750 kPa). Because gaseous fuel may be stored under such temperatures and pressures, it may be necessary for the gaseous fuel to be kept in a vacuum insulated tank such as a pressurized cryogenic tank. The gaseous fuel source 50 can be configured with a pressure relief valve 53 that serves to relieve pressure from the fuel source 50 when it exceeds a predetermined pressure level. In some cases, the pressure relief valve can be configured to open when the pressure in the fuel source tank 50 exceeds 1400 kPa. Gaseous fuel can be drawn from the gaseous fuel source 50 through a gaseous supply line 51 by a fuel pump 52.

A variable displacement cryogenic pump 52 is controlled by an electronic control module (ECM) 15 to pump liquefied natural gas through a vaporizer 54 for expansion into a gas that can be maintained in an accumulator 60 and then through a high pressure gas filter 58.

The fuel pump 52 may be configured as a variable displacement cryogenic pump. Fuel pump 52 pressurizes and delivers gaseous fuel to a vaporizer 54, which serves to vaporize the liquid natural gas. Such vaporizer 54 serves to heat and/or vaporize cryogenic and low temperature fluids such as the cryogenic liquid natural gas. The vaporized gas can then be delivered to an accumulator 60 via gaseous supply lines 57 and filter 58. In alternative embodiments, a secondary filter can be placed between filter 58 and the accumulator 60 to further filter contaminants within gaseous supply lines 57.

A gas pressure control device 56 according to the present disclosure includes an electronically controlled valve that supplies a controlled quantity of gaseous fuel from the supply side (accumulator 60) to the gaseous fuel common rail 30. The pressure regulator 56 can serve as a control valve for storing a portion of the gaseous fuel in tank 80. The gaseous fuel may be stored as compressed natural gas that may be maintained at a temperature of 60° C. and a pressure of 1 MPa. When the pressure in the tank exceeds 1 MPa, for example, the pressure regulator can diffuse or vent off some of the compressed natural gas contained in the tank 80.

The tank 80 serves as a holding tank for compressed natural gas that is supplied from the vaporizer 54. In the event that the dual fuel system 10 is required to run such as under very cold weather temperatures, the compressed natural gas stored in tank 80 can serve as fuel for a heat source 90. In this manner, heat can be generated and supplied to the vaporizer 54 to convert pressurized liquid natural gas to compressed natural gas. Such compressed natural gas can then be supplied to the gaseous rail 30 for use by the engine 5. Thus, in cold weather, readily available compressed natural gas can be supplied to the gaseous rail 30.

While the heat source 90 may be any one of a variety of different types of heaters, such heat sources can be characterized and/or configured to utilize stored compressed natural gas as a source of fuel for activation.

A fuel-conditioning module 32 can be in operative communication with the vaporizer 54, the pressure regulator 56, and the gaseous fuel rail 30. The fuel-conditioning module 32 is intended to maintain the pressure of the gaseous fuel delivered to a gaseous fuel rail 30 at a pressure that is at least 5 MPa below that of the diesel fuel pressure in the diesel fuel rail 20. For instance, within the dual fuel common rail fuel system 10, diesel fuel within the diesel fuel rail 20 may be at a pressure of 40 MPa, while gaseous fuel within the gaseous fuel rail 30 may be at a pressure of 35 MPa.

An electronic control module (ECM) 15 may control various components of dual fuel common rail fuel system 10. For example, the ECM 15 may control the diesel fuel pump 16, LNG fuel pump 52, pressure regulator 56, and injectors 70. Those skilled in the art will recognize that fuel system 10 may further include other components that can also be controlled by ECM 15. Further, the ECM 15 can be in communication with a sensor coupled to the tank 80 and configured to monitor a pressure level of CNG in the tank 80. The ECM 15 can be configured to control the operation of the pressure regulator 56 to recharge the tank 80 with CNG when the CNG pressure level in the tank 80 drops to a predetermined level.

### INDUSTRIAL APPLICABILITY

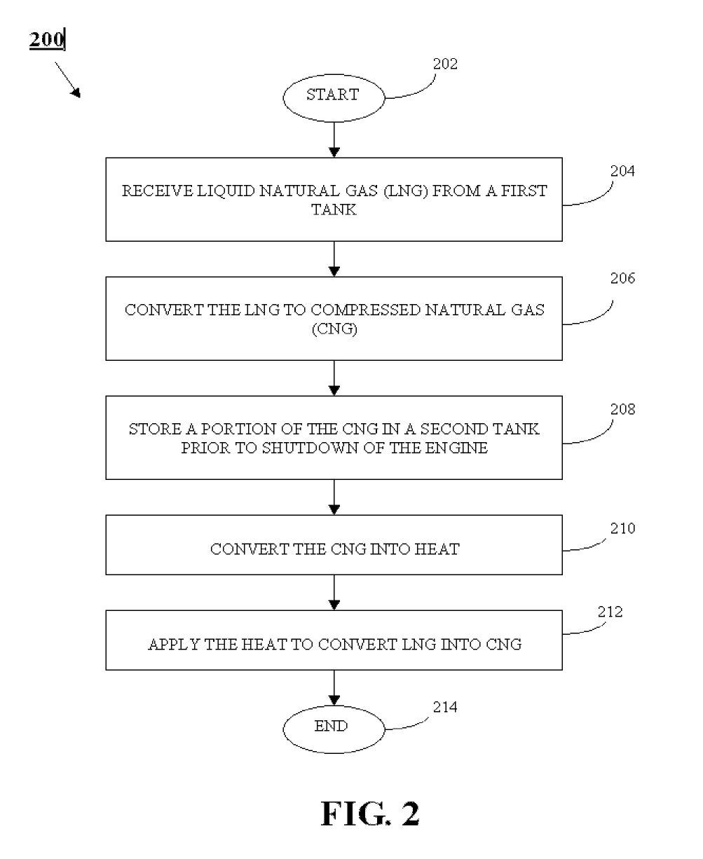

The disclosed system 10 can be applicable to any dual fuel machine or engine that requires an efficient method and system to run in cold weather conditions. The operation of the system 10 will now be explained in connection with the flowchart of FIG. 2.

FIG. 2 illustrates in flow-chart form a method for running an engine 5 according to one embodiment. The method starts in operation 202. In operation 204, a vaporizer 54 may receive liquid natural gas (LNG) from a first tank 50. The vaporizer 54 serves to convert the LNG to compressed natural gas (CNG), in operation 206. Prior to shutdown of the engine 5, a portion of the CNG is stored in a second tank 80, in operation 208. In operation 210, the CNG stored in the second tank 80 is supplied to a heat source 90 to convert the CNG into heat. In operation 212, the heat from the heat source 90 is applied to the vaporizer 54 to convert LNG to CNG, during a subsequent start-up of the engine 5. The method ends in operation 214.

The dual fuel system 10 described herein can be used in mobile applications using dual fuel engines, wherein there is a generally some time requirement where the engine 5 operates on diesel fuel only while the natural gas system comes up to operating pressures and temperatures. As such, system 10 alleviates the warm up delay by providing a CNG tank 80 that is recharged prior to a system shutdown. System 10 provides a gas-fueled heat source 90 (e.g., a burner, block heater, etc) to support the conversion of the natural gas from a liquid to a gaseous form. This allows for an also immediate supply of compressed natural gas to the engine 5. As such, compressed natural gas is readily available to the engine 5 shortly after start-up. The vaporizer 54 can serve as a forced vaporizer in that it uses an externally applied heat source 90 to vaporize LNG. Alternative embodiments that embody the CNG tank 80, heat source 90 and vaporizer 54 as a single component is also contemplated.

While this disclosure includes particular examples, it is to be understood that the disclosure is not so limited. Numerous modifications, changes, variations, substitutions and equivalents will occur to those skilled in the art without departing from the spirit and scope of the present disclosure upon a study of the drawings, the specification and the following claims.

What is claimed is:

1. A system, comprising:
an engine;
a vaporizer configured to convert liquid natural gas (LNG) to compressed natural gas (CNG);
a tank configured to store CNG; and
a heat source in fluid communication with the tank and fueled by the CNG, the heat source configured to apply heat to the vaporizer.

2. The system of claim 1, further comprising:
a controller in communication with the tank and configured to:
monitor a pressure of the CNG in the tank, and
direct CNG to the tank when the pressure of the CNG in the tank drops to a predetermined level.

3. The system of claim 1, further comprising:
a pump in communication with the vaporizer, the pump configured to direct the LNG to the vaporizer.

4. The system of claim 3, wherein the pump is a variable delivery cryogenic pump.

5. The system of claim 1, wherein the engine is an internal combustion engine.

6. A system for running an engine, comprising:
a first tank for storing liquid natural gas (LNG);
a pump in communication with the first tank and configured to pump the LNG from the first tank;
a vaporizer in communication with the pump, the vaporizer configured to receive the LNG from the first tank via the pump and convert the LNG into compresses natural gas (CNG);
a second tank in communication with the vaporizer and configured to store CNG; and
a heat source in communication with the second tank, the heat source configured to use the stored CNG to apply to the vaporizer.

7. The system of claim 6, wherein the first tank is an LNG tank.

8. The system of claim 6, wherein the pump is a variable delivery cryogenic pump.

9. The system of claim 6, further comprising:
a controller in communication with the tank and configured to:
monitor a pressure of the CNG in the tank, and
direct CNG to the tank when the pressure of the CNG in the tank drops to a predetermined level

10. A method for running an engine, comprising:
receiving liquid natural gas (LNG) from a first tank;
converting the LNG to compressed natural gas (CNG);
storing a portion of the CNG in a second tank prior to shutdown of the engine;
converting the CNG into heat; and
applying the heat to convert LNG into CNG.

11. The method of claim 10, wherein the first tank is a pressurized cryogenic LNG tank.

12. The method of claim 10, further comprising:
monitoring the pressure of the CNG in the second tank, and
recharging the second tank with CNG when the pressure of the CNG drops to a predetermined level.

13. A fuel system, comprising:
a first fuel source;
a first fuel rail;
at least one first fuel pump configured to pressurize a first fuel associated with the first fuel source;
a vaporizer in communication with the first fuel source via the first fuel pump, the vaporizer configured to convert the first fuel from a liquid form to a gaseous form;
a tank in communication with the vaporizer and configured to store the gaseous form of the first fuel;
a heat source in communication with the tank, the heat source configured convert the gaseous form of the first fuel into heat and apply the heat to the vaporizer;
a second fuel source;
a second fuel rail;
at least one second fuel pump configured to pressurize a second fuel associated with the second fuel source and deliver the second fuel to the second fuel rail;
a quill in communication with the first fuel from the first fuel rail and the second fuel from the second fuel rail; and
at least one dual fuel injector configured to receive both the first fuel and the second fuel from the quill.

14. The fuel system of claim 13, further comprising:
a controller in communication with the tank and configured to:
monitor a pressure of the CNG in the tank, and
direct CNG to the tank when the pressure of the CNG in the tank drops to a predetermined level

15. The fuel system of claim 13, wherein the second fuel is at a pressure approximately 5 MPa higher than the first fuel.

16. The fuel system of claim 13, wherein the first fuel is a gaseous fuel and the second fuel is a diesel fuel.
